(19) United States
(12) Patent Application Publication
(10) Pub. No.: US 2015/0046368 A1
(43) Pub. Date: Feb. 12, 2015

(54) SYSTEM FOR DETERMINING WHETHER TO NOTIFY AGREEMENT TERMS, METHOD, AND MEDIUM

(71) Applicant: CANON KABUSHIKI KAISHA, Tokyo (JP)

(72) Inventor: Yuichi Inoue, Kawasaki-shi (JP)

(21) Appl. No.: 14/338,128

(22) Filed: Jul. 22, 2014

(30) Foreign Application Priority Data
Aug. 9, 2013 (JP) 2013-166691

(51) Int. Cl. G06Q 10/10

(52) U.S. Cl. CPC G06Q 10/10
USPC 705/342

(57) ABSTRACT

To provide a system for determining whether to present agreement terms to a user at the time of use of a web service. The present invention is a system for determining whether to notify agreement terms to use a predetermined function to a user, the system having: an acquisition unit configured to acquire language information for specifying a language corresponding to a user and agreement information on a date of agreement of the agreement terms by the user; and a determination unit configured to, in the case where a request to use the predetermined function from a user is received, determine whether to notify the agreement terms to the user based on the date of the agreement terms corresponding to the language information acquired by the acquisition unit of a plurality of agreement terms corresponding to a plurality of languages, respectively, and the agreement information acquired by the acquisition unit.

### BACKGROUND OF THE INVENTION

1. Field of the Invention

The present invention relates to a system for determining whether to notify agreement terms, a method, and a medium. Specifically, the present invention relates to a system for determining whether to notify terms to which a user is asked to agree or reagree at the time of use of a function, a method, and a medium.

2. Description of the Related Art

In recent years, a service (hereinafter, web service) in a system is used, in which the body of a program is arranged in a web server and the program is used by accessing the web server from an information terminal. The provider of the web service (hereinafter, service provider) presents agreement terms to a user who uses the web service from an information terminal. The agreement terms include points to note in the case where the service provider side handles user information at the time of use of the web service, rules for the user side at the time of use of the web service, etc. The user reads the agreement terms and notifies the service provider of agreement to the agreement terms. Upon receipt of agreement of the user, the service provider permits the user to use the web service. Further, in the case where the agreement terms presented to the user by the service provider are changed, it is necessary for the service provider to newly present the changed agreement terms to the user who has agreed to the agreement terms before the change and to gain agreement again from the user. (See Japanese Patent Laid-Open No. 2012-248018)

### SUMMARY OF THE INVENTION

In the general web service, in the case where the function is changed, all the users who use the function begin to use the changed function at the same time. In the case where a certain function is deleted from the web service by the change of the function, it is difficult for a user to continue to use the function before the change. Further, there is also a case where the service provider provides different functions that can be used according to the display languages (Japanese, English, French, etc.) used on the information terminal side.

Further, in the general web service, the agreement terms at the time of use of the web service are managed in a centralized manner by the web server. Consequently, in the case where the agreement terms managed by the web server are changed, the agreement terms for all the users are changed at the same time. Further, regardless of whether or not the function of the web service is changed, there is a case where the web service compatible languages are increased or reduced in number or exchanged. In addition to this, there is also a case where the service provider changes the wording of the agreement terms in a specific language and the contents of the agreement terms managed by the web service are not necessarily the same in all the languages. Further, the agreement terms in all the languages are not necessarily changed at the same time.

It is necessary for a user to agree or reagree to the agreement terms at the time of use of the web service. However, there is a case where the service provider frequently asks a user for agreement to the agreement terms despite that the agreement terms are not at all changed, and this is troublesome to the user. On the other hand, it is not preferable to continue to permit a user to use the web service without asking the user for reagreement in the case where the service provider has changed the agreement terms.

The present invention has been made in view of the circumstances described above and an object thereof is to provide a system for appropriately determining whether to notify agreement terms to a user at the time of use of the function, a method, and a medium.

The present invention of the application is a system for determining whether to notify agreement terms to use a predetermined function to a user, the system having: an acquisition unit configured to acquire language information for specifying a language corresponding to a user and agreement information on the date of agreement to the agreement terms by the user; and a determination unit configured to determine, in the case where a request to use the predetermined function from the user is received, whether to notify the agreement terms to the user based on the date of the agreement terms corresponding to the language information acquired by the acquisition unit of a plurality of agreement terms corresponding to a plurality of languages, respectively, and the agreement information acquired by the acquisition unit.

By the present invention, it is possible to provide a system for appropriately determining whether to notify agreement terms to a user at the time of use of a function, a method, and a medium.

Further features of the present invention will become apparent from the following description of exemplary embodiments (with reference to the attached drawings).

### BRIEF DESCRIPTION OF THE DRAWINGS

FIG. 1 is a diagram showing a configuration of a system according to an embodiment of the present invention;

FIG. 2 is a diagram showing a configuration of a web server;

FIG. 3 is a diagram showing data etc. stored in a storage unit of the web server;

FIG. 4 is a diagram showing a configuration of an information terminal;

FIG. 5 is a diagram showing an example of a language selection screen displayed on a display device of the information terminal;

FIG. 6 is a flowchart of agreement terms display determination processing;

FIG. 7 is a flowchart of language determination processing;

FIG. 8 is a flowchart of agreement terms display processing;

FIG. 9 is a flowchart of agreement information update processing;

FIG. 10 is a diagram showing an example of an intention check dialog at the time of agreement displayed on the display device of the information terminal;

FIG. 11 is a diagram showing an example of an intention check dialog at the time of reagreement displayed on the display device of the information terminal;

FIG. 12 is a diagram for explaining a specific example 1 of the present invention; and

FIG. 13 is a diagram for explaining a specific example 2 of the present invention.

### DESCRIPTION OF THE EMBODIMENTS

Hereinafter, with reference to the attached drawings, preferred embodiments of the present invention are explained in detail. The contents described in the scope of the claims are not narrowly interpreted by the embodiments explained below. Further, all the combinations of the features explained below are not necessarily indispensable as means for solving problems of the present invention.

<System Configuration>

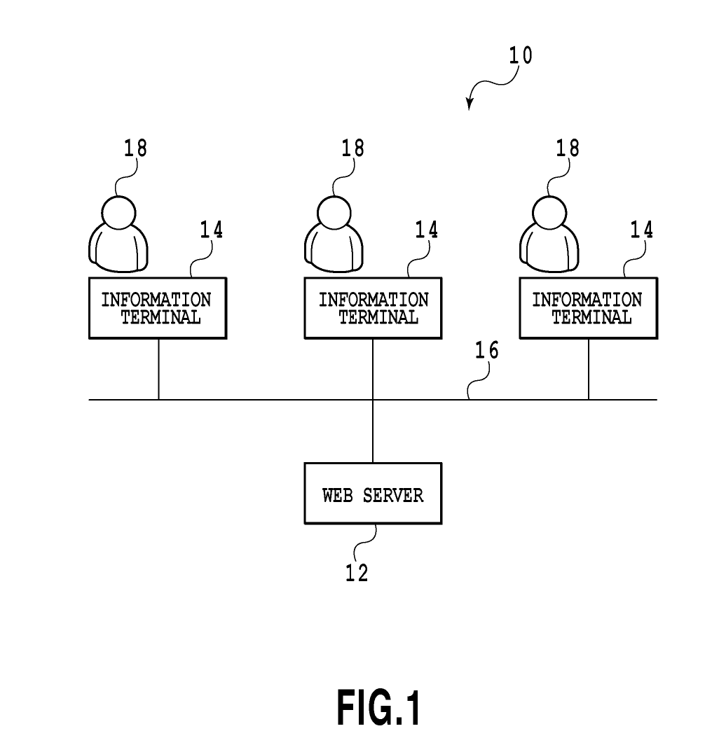

FIG. 1 is a diagram showing an outline of a configuration of a system 10 for determining whether to display agreement terms according to an embodiment of the present invention. As shown in FIG. 1, a web server 12 and information terminals 14 are connected to one another via a communication unit 16, such as a network and capable of communicating with one another. The communication unit referred to here may be, for example, the Internet, an intranet, etc.

The web server 12 manages the body of a program in a storage unit. Upon receipt of a request to use the program from the information terminal 14, the web server 12 executes the program on the web server 12 and provides the result of execution of the program to the information terminal 14 as a web service. The information terminal 14 is a terminal for communicating with the web server 12 to use a web service. A user 18 uses a web service via the information terminal 14.

<Configurations of Web Server and Information Terminal>

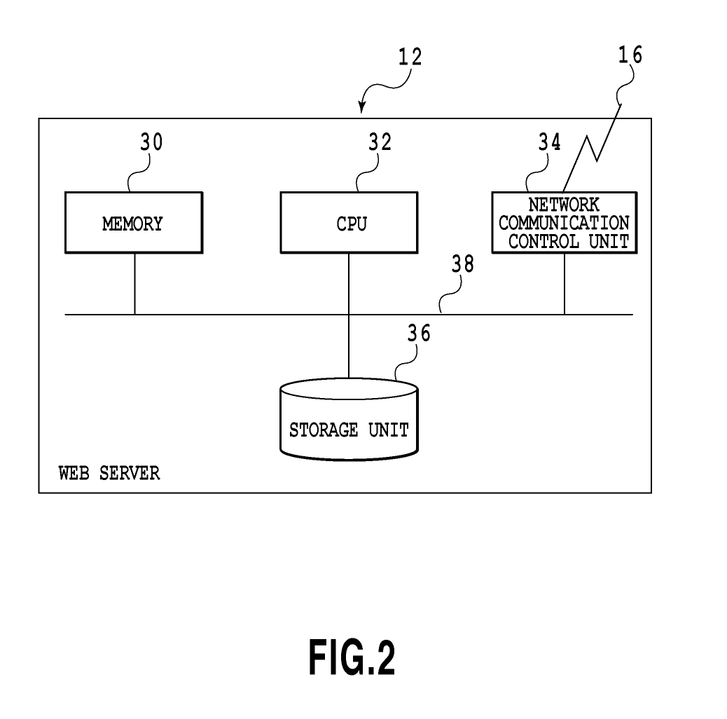

With reference to FIG. 2 to FIG. 4, configurations of the web server 12 and the information terminal 14 are explained.

FIG. 2 is a diagram showing a configuration of the web server 12 according to the embodiment of the present invention. As shown in FIG. 2, the web server 12 includes a memory 30, a CPU 32, a network communication control unit 34, and a storage unit 36, which are connected to one another by a bus 38.

The CPU 32 reads and executes various kinds of programs and data stored in the storage unit 36. The memory 30 is used as a work memory at the time of, for example, execution of programs by the CPU 32. The network communication control unit 34 is a control unit configured to transmit and receive information via the communication unit 16.

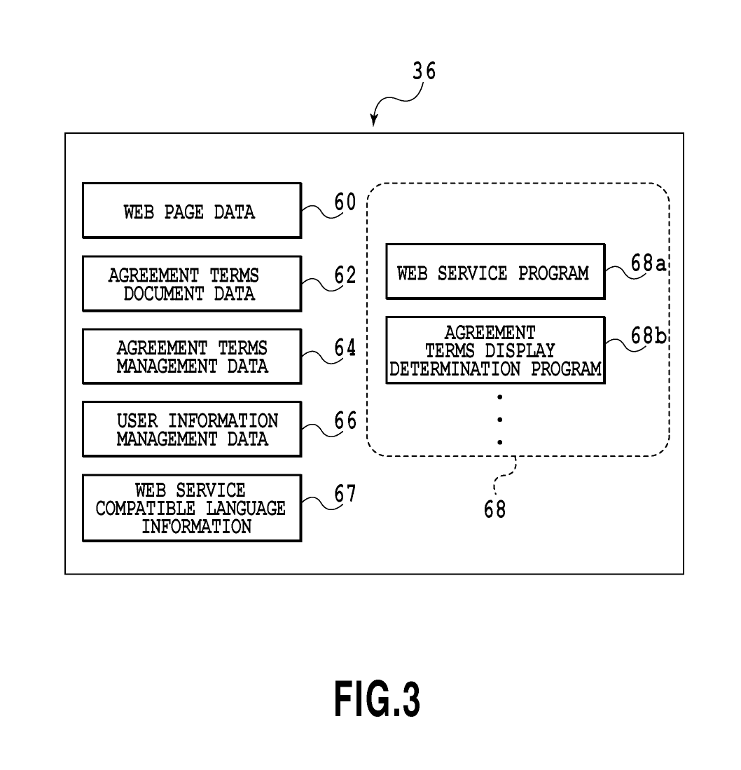

FIG. 3 is a diagram showing data, information, and programs stored in the storage unit 36 of the web server 12. The storage unit 36 is a nonvolatile rewritable storage unit including an HDD (Hard Disk Drive), a flash memory, etc. In the storage unit 36, programs 68 are stored, such as a web service program 68a, which is the body of the program executed for the web server 12 to transmit a web service to the information terminal 14, and an agreement terms display determination program 68b. Further, in the storage unit 36, web page data 60 of a web page displayed on the information terminal 14, user information management data 66 for the user 18, web service compatible language information 67, agreement terms document data 62, agreement terms management data 64, etc., are also stored.

The agreement terms document data 62 stored in the storage unit 36 is data of part or the whole of the agreement terms classified and stored for each compatible language at the time of provision of a web service. The agreement terms management data 64 includes update date information of the agreement terms and the update date information of the agreement terms is stored for each language of the compatible languages.

The agreement terms document data 62 is overwritten and stored in the case where the agreement terms are changed. Normally, in the case where the agreement terms document data 62 is overwritten, the agreement terms management data 64 including the update date information of the agreement terms is overwritten and stored. However, even in the case where the agreement terms document data 62 is overwritten, the agreement terms management data 64 is not necessarily overwritten and changed depending on the contents of the change of the agreement terms.

In the case where a compatible language is added in the web service, the web service compatible language information 67 is updated and the agreement terms document data 62 comes to newly include the document data of the agreement terms described in the added compatible language. Further, to the agreement terms management data 64, the update date information associated with the added compatible language is added. On the contrary, in the case where a compatible language is deleted in the web service, the web service compatible language information 67 is updated and the agreement terms document data described in the compatible language deleted from the agreement terms document data 62 is deleted. Further, from the agreement terms management data 64, the update date information associated with the deleted compatible language is deleted.

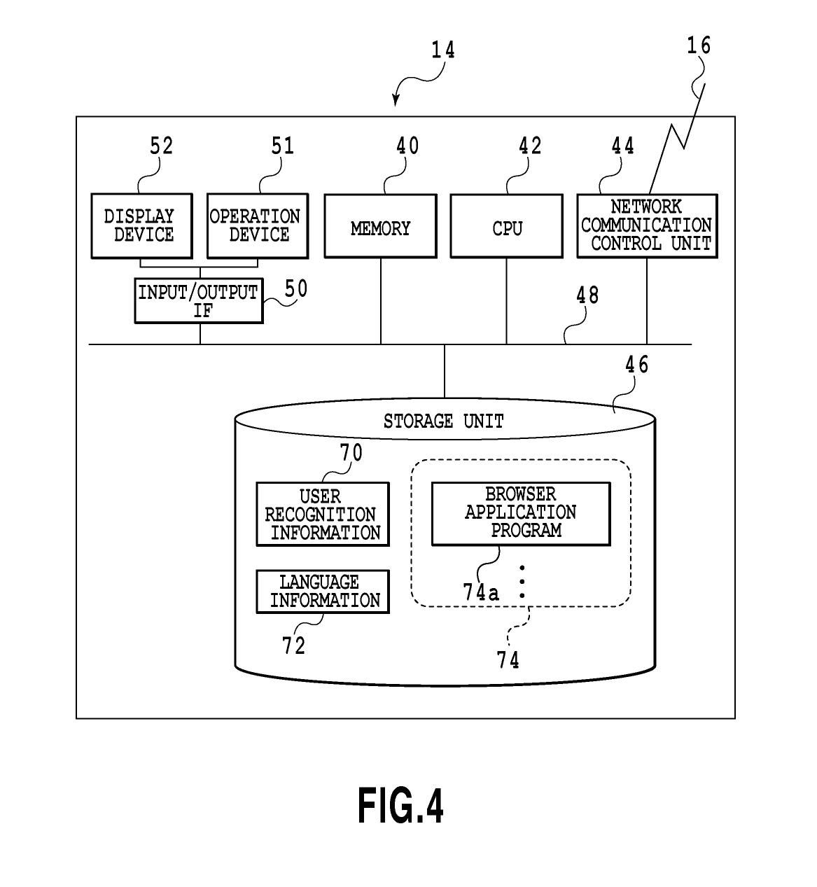

FIG. 4 is a diagram showing a configuration of the information terminal 14. As shown in FIG. 4, the information terminal 14 includes a memory 40, a CPU 42, an input/output IF 50, an operation device 51, a display device 52, a network communication control unit 44, and a storage unit 46, which are connected to one another via a bus 48.

The CPU 42 executes various kinds of programs stored in the storage unit 46. The memory 40 is used as a work memory at the time of execution of programs by the CPU 42. To the input/output IF 50, the operation device 51 and the display device 52 are connected. The operation device 51 is operated by the user 18 and includes, for example, a keyboard, a mouse, buttons, a touch panel, etc. The display device 52 displays characters, images, etc., by the control of the CPU 42 and includes, for example, a monitor etc. The network communication control unit 44 is a control unit configured to transmit and receive information via the communication unit 16. In the storage unit 46, programs 74 are stored, such as a browser application program 74a for browsing a web page to use a web service provided by the web server 12. Further, in the storage unit 46, various kinds of data are also stored, such as user recognition information 70 on the user who operates the information terminal 14 and language information 72. In the case where the user 18 uses a web service provided by the web server 12, the information terminal 14 transmits information on the user 18 to the web server 12 and acquires user authentication information as a response thereof. Next, the information terminal 14 stores the user authentication information in the storage unit 46 as the user recognition information 70. During the communication between the information terminal 14 and the web server 12, the information terminal 14 notifies the web server 12 of that the access is from the user 18 by transmitting the user recognition information 70 stored in the storage unit 46 to the web server 12 at all times.

<Operation of System>

The operation of the system for determining whether to display the agreement terms according to the embodiment of the present invention is explained.

In the case where the user 18 uses a web service provided by the web server 12, the information terminal 14 transmits information of the user 18 who operates the information terminal 14 to the web server 12 and user authentication is performed. After the web server 12 specifies the user 18 who operates the information terminal 14 by the user authentication, the information terminal 14 transmits a web service use request to the web server 12. In the case where the information terminal 14 transmits the web service use request, the information terminal 14 transmits the language information 72 and the user recognition information 70 stored in the information terminal 14 to the web server 12. The web service use request may include the language information 72 and the user recognition information 70.

The language information transmitted from the information terminal 14 to the web server 12 indicates which language the web server 12 should use for the user 18 in the web service. The language information transmitted to the web server 12 is not limited to the language information 72 that the information terminal 14 stores in the storage unit 46 and may be language information set as a set value of the browser application program 74a. Alternatively, the language information transmitted to the web server 12 may be transmitted to the web server 12 by displaying a language selection screen for selecting a language on the display device 52 of the information terminal 14 and by causing the user 18 to select a language by the operation device 51. In this case, the language information transmitted to the web server 12 may be language information different from the language information 72 stored in the storage unit 46 of the information terminal 14. Further, the language information transmitted to the web server 12 may be a piece of information or a plurality of pieces of information including language information. In such a case, for example, information combining the language information and information different from the language information is transmitted to the web server 12. The above-mentioned information different from the language information is, for example, country/region information indicating a country or region compatible with the information terminal 14 and priority information indicating the priority of the language. For example, in the case where the language information indicates a plurality of languages, the priority information indicates priority of each of the plurality of languages. The web server 12 specifies the language with the highest priority indicated by the priority information as the language compatible with the information terminal 14 at the time of analysis of the language information in processing, to be described later.

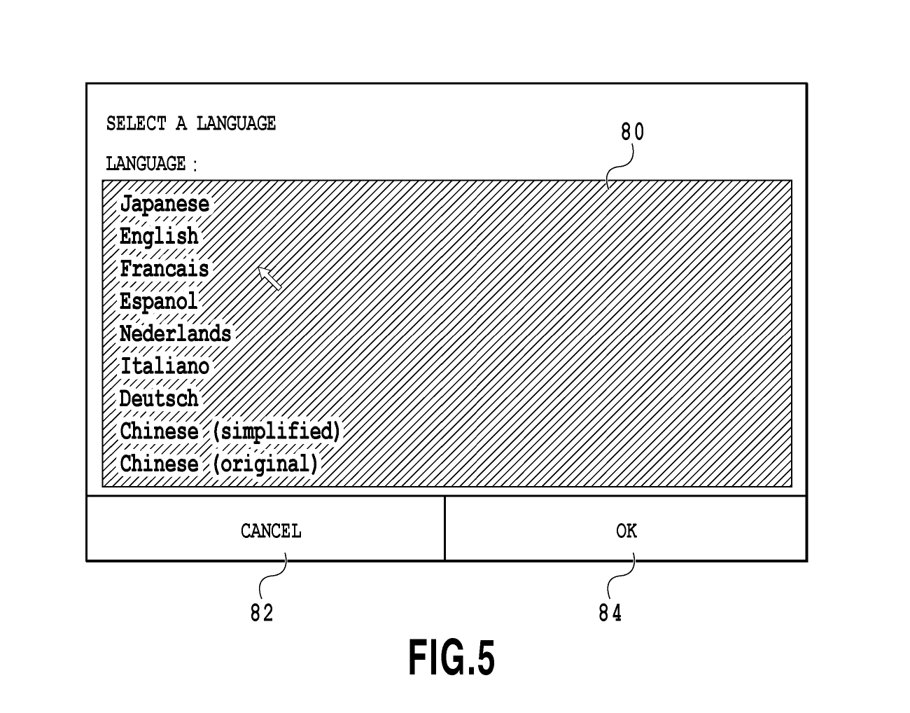

FIG. 5 shows an example of a language selection screen displayed on the display device 52 of the information terminal 14. On a display unit 80, a list of web service compatible languages is displayed. In the case where the user 18 selects any one of one or more enumerated languages and presses down an OK button 84 by using the operation device 51 of the of the information terminal 14, the information terminal 14 transmits the language information to the web server 12. In the case where the user 18 presses down a Cancel button 82, the information terminal 14 exits the display of the language selection screen without transmitting the language information to the web server 12.

In the system according to the present invention, in the case where the web server 12 receives the web service use request from the information terminal 14, the agreement terms display determination program 68b activates and the agreement terms display determination processing is performed before the web service is provided to the information terminal 14.

<Agreement Terms Display Determination Processing>

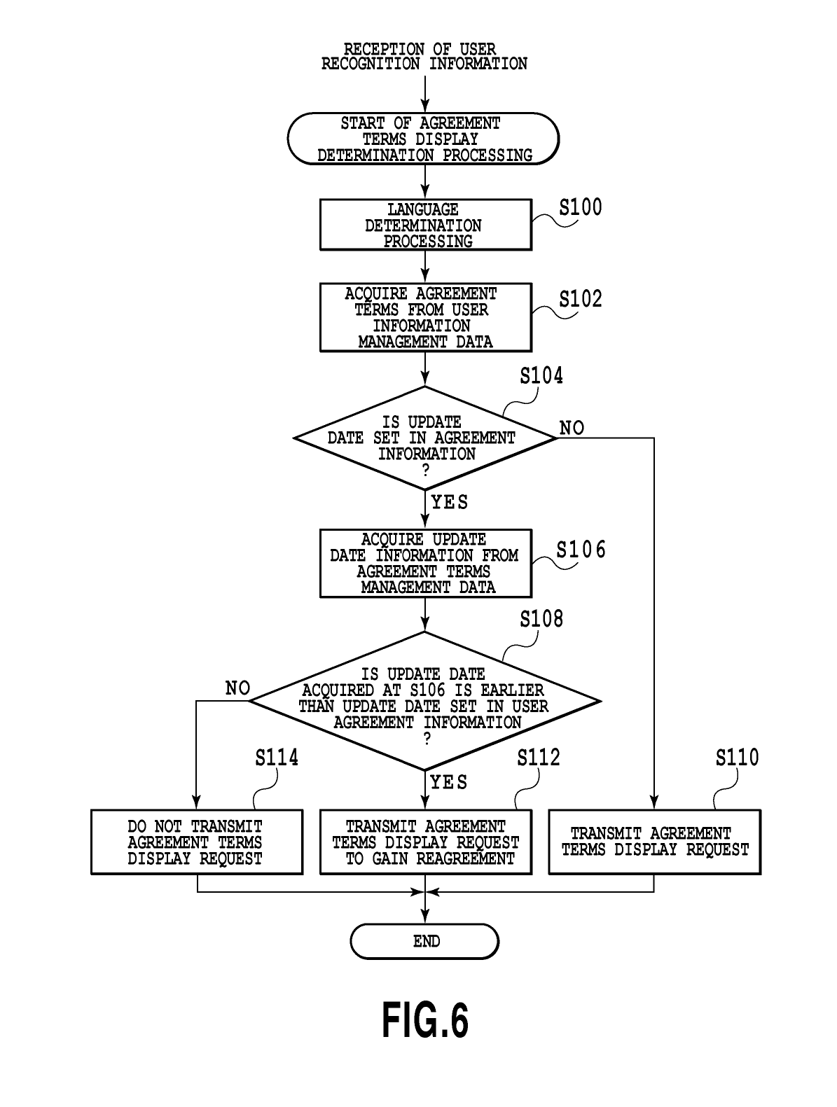

The agreement terms display determination processing performed by the web server 12 having received the user recognition information transmitted from the information terminal 14 is explained by using FIG. 6.

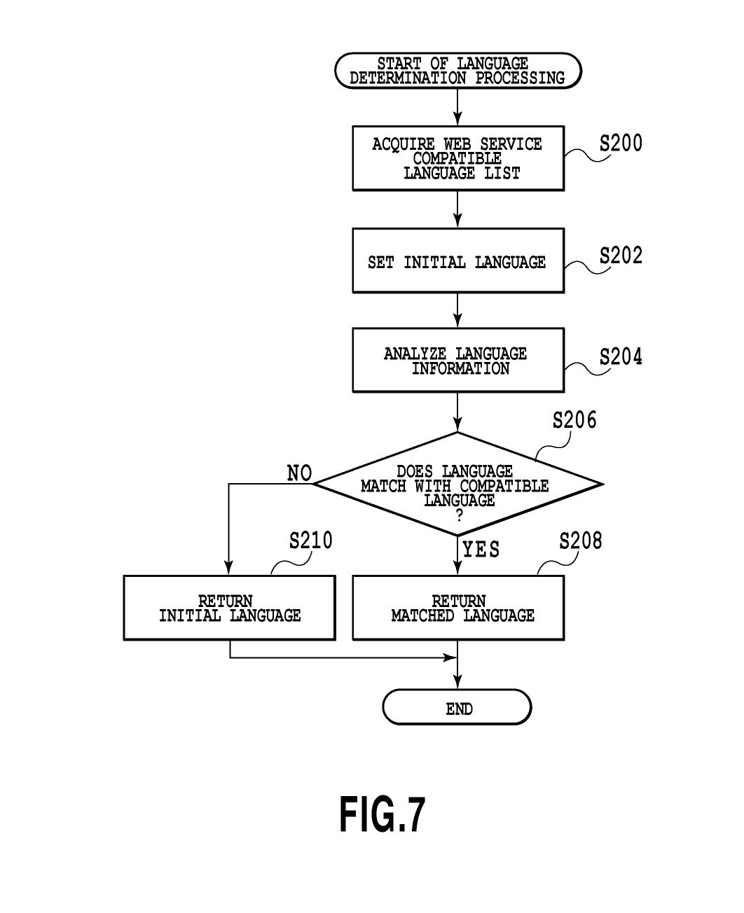

At step S100, the web server 12 performs language determination processing to acquire a web service compatible language from the language information transmitted from the information terminal 14. The language determination processing will be explained later in detail by using FIG. 7. As the result of the language determination processing, the web server 12 acquires one of the web service compatible languages as a return value and uses the acquired language information (indicating one of the web service compatible languages) in the subsequent steps. Next, the processing proceeds to step S102.

At step S102, the web server 12 acquires user agreement information from the user information management data 66 by using the user recognition information 70 transmitted from the information terminal 14. In the case where the user has agreed to the agreement terms before, in the user agreement information to be acquired, update date information indicating when the agreement terms to which the user has agreed before were updated is set. Next, the processing proceeds to step S104.

At step S104, the web server 12 determines whether or not the update date information is set in the user agreement information acquired at step S102. In the case where it is determined that the update date information is set in the user agreement information, the processing proceeds to step S106. In the case where it is determined that the update date information is not set in the user agreement information, the processing proceeds to step S110.

At step S106, the web server 12 acquires the update date information of the agreement terms document data 62 in the language acquired at step S100 from the agreement terms management data 64. The update date information acquired here indicates the date of the most recent update of the agreement terms document data 62 in the language acquired at step S100. Next, the processing proceeds to step S108.

At step S108, the web server 12 compares the update dates by using the update date information set in the user agreement information acquired at step S102 and the update date information of the agreement terms document data 62 acquired at step S106. Due to this, whether or not the update date indicated by the update date information of the agreement terms document data 62 acquired at step S106 is earlier than the update date indicated by the update date information set in the user agreement information acquired at step S102 is determined. In the case where it is determined that the update date indicated by the update date information of the agreement terms document data 62 acquired at step S106 is earlier than the update date indicated by the update date information set in the user agreement information acquired at step S102, the processing proceeds to step S112. In other cases, the processing proceeds to step S114.

At step S110, the web server 12 determines that the user 18 having transmitted the web service use request by the information terminal 14 is a user who uses the web service for the first time, and transmits the agreement terms display request to the information terminal 14 and ends the agreement terms display determination processing.

At step S112, the web server 12 determines that the user 18 having transmitted the web service use request by the information terminal 14 has used the web service before, but the service provider has changed the agreement terms, and therefore, the necessity to ask the user 18 for reagreement arises. In this case, the web server 12 transmits the agreement terms display request to the information terminal 14 in order to gain reagreement of the user 18 and ends the agreement terms display determination processing.

At step S114, the web server 12 determines that the agreement terms display is not necessary and ends the agreement terms display determination processing without transmitting the agreement terms display request.

<Language Determination Processing>

The language determination processing at step S100 in FIG. 6 is explained by using FIG. 7. As described previously, in the case where the information terminal 14 transmits the web service use request, the information terminal 14 transmits language information to the web server 12. There is a case where the language information transmitted from the information terminal 14 is defined uniquely by the browser application program 74a of the information terminal 14 as language information. In such a case, it is necessary for the web server side to convert the language information transmitted from the information terminal 14 into language information that can be processed by the web server 12.

At step S200, the web server 12 refers to the web service compatible language information 67 and acquires a compatible language list. Next, the processing proceeds to step S202.

At step S202, the web server 12 selects one compatible language from the compatible language list acquired at step S200 and sets the language as an initial language. Next, the processing proceeds to step S204.

At step S204, the web server 12 analyzes the language information transmitted from the information terminal 14. Specifically, the web server 12 collates the language information transmitted from the information terminal 14 with the compatible language list acquired at step S200. By the collation with the compatible language list, whether the language specified by the language information transmitted from the information terminal 14 exists in the compatible language list is made clear. At the time of collation with the compatible language list, it may also be possible to prepare a conversion table for management in advance and to perform collation by using the conversion table. Next, the processing proceeds to step S206.

At step S206, upon receipt of the result at step S204, the web server 12 determines whether or not the language specified by the language information transmitted from the information terminal 14 agrees with any language in the compatible language list. In the case where it is determined that the language specified by the language information transmitted from the information terminal 14 agrees with any language in the compatible language list, the processing proceeds to step S208. In other cases, the processing proceeds to step S210.

At step S208, the web server 12 returns the language specified by the determination at step S206 as the result of the language determination processing and ends the language determination processing.

At step S210, the web server 12 returns the initial language set at step S202 as the result of the language determination processing and ends the processing.

<Agreement Terms Display Processing>

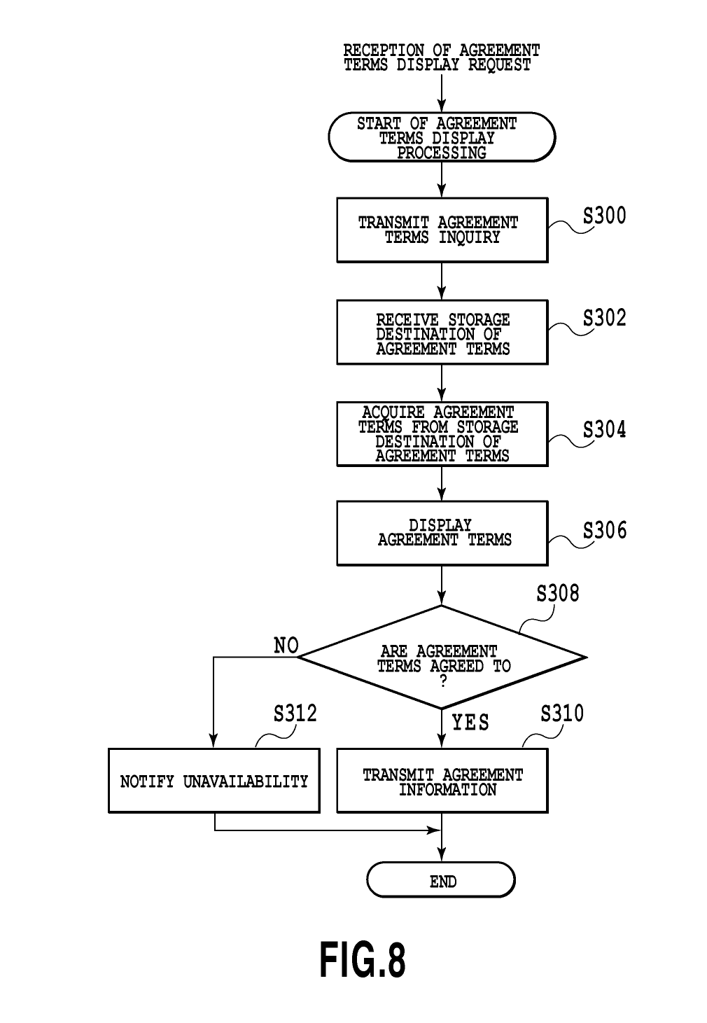

As described previously, in the case where the information terminal 14 transmits the web service use request to the web server 12, the agreement terms display determination processing shown in FIG. 6 is performed. In the case where the information terminal 14 receives the agreement terms display request transmitted from the web server 12 as the result of performing the agreement terms display determination processing, the agreement terms display processing is performed in the information terminal 14. Hereinafter, the agreement terms display processing is explained by using FIG. 8.

At step S300, the information terminal 14 inquires the storage destination of the agreement terms document data by transmitting an agreement terms inquiry to the web server 12. Next, the processing proceeds to step S302.

At step S302, as a response to the agreement terms inquiry, the information terminal 14 receives information on the storage destination of the agreement terms document data. Next, the processing proceeds to S304.

At step S304, the information terminal 14 acquires the agreement terms document data from the web server 12 by using the information on the storage destination of the agreement terms received at step S302. Next, the processing proceeds to step S306.

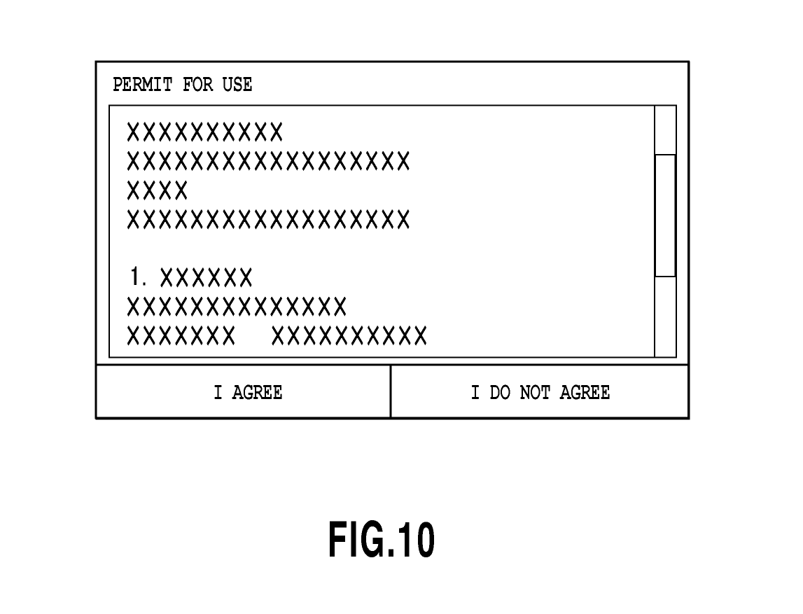

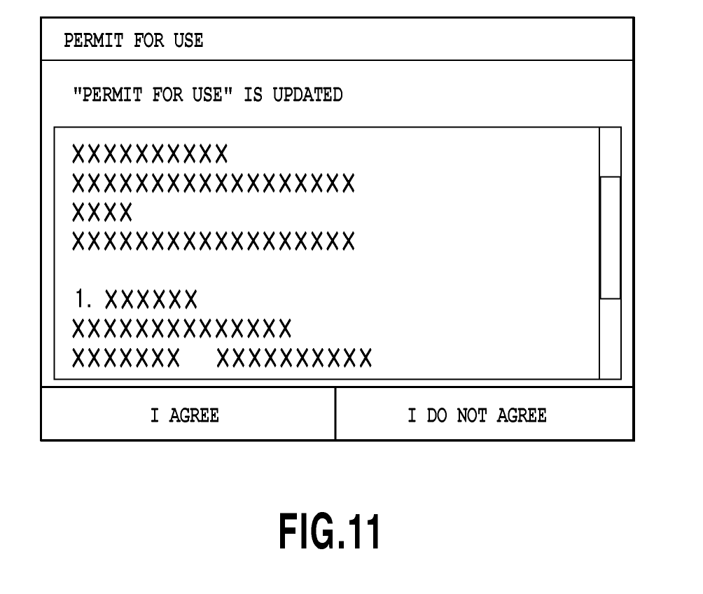

At step S306, the information terminal 14 displays the acquired agreement terms document data on the display device 52. In the case where the agreement terms document data is displayed on the display device 52, an “I agree” button and an “I do not agree” button are also displayed as illustrated in FIG. 10. By causing the user 18 to press down one of the buttons via the operation device 51, whether or not the user 18 will agree to the agreement terms is checked. It may also be possible to display a screen as illustrated in FIG. 11 so that the user 18 who sees the intention check dialog can determine whether the agreement terms display is produced for the first time for the user 18 or the agreement terms display is produced to gain reagreement of the user 18 in the case where the agreement terms display is produced in order to gain reagreement. In the intention check dialog illustrated in FIG. 11, the wording “‘Permit for use’ is updated” is displayed and this point is the difference from FIG. 10. Next, the processing proceeds to step S308.

At step S308, after the user 18 presses down the button of the intension check dialog by using the operation device 51, the information terminal 14 determines whether or not the user 18 has agreed to the agreement terms. In the case where it is determined that the user 18 has pressed down the “I agree” button and agreed to the agreement terms, the processing proceeds to S310. In the case where it is determined that the user 18 has pressed down the “I do not agree” button and not agreed to the agreement terms, the processing proceeds to S312.

At step S310, the information terminal 14 transmits agreement information indicating that the user 18 has agreed to the agreement terms to the web server 12 and ends the agreement terms display processing.

At step S312, the information terminal 14 displays a message to the effect that the web service is not available on the display device 52 and ends the agreement terms display processing.

<Agreement Information Update Processing>

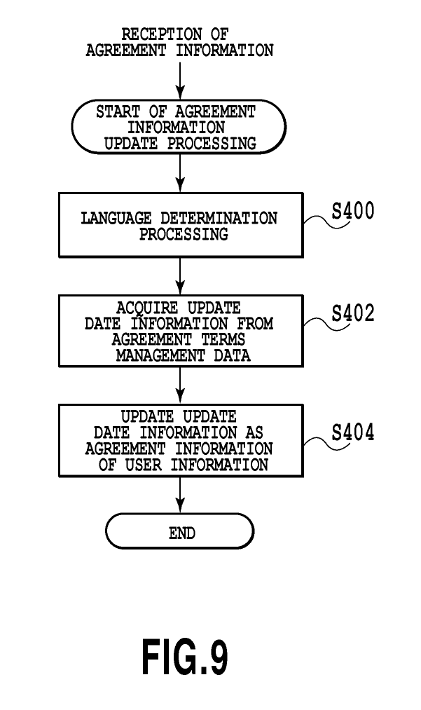

Upon receipt of the agreement information from the information terminal 14, the web server 12 performs agreement information update processing. Hereinafter, the agreement information update processing is explained by using FIG. 9.

At step S400, the web server 12 acquires language information by performing language determination processing. The language determination processing at step S400 is the same as the language determination processing explained in FIG. 7, and therefore, detailed explanation is omitted. Next, the processing proceeds to step S402.

At step S402, the web server 12 acquires the update date information of the agreement terms document data in the compatible language from the agreement terms management data 64 by using the language information acquired at step S400. Next, the processing proceeds to step S404.

At step S404, the web server 12 updates the agreement information of the user information included in the user information management data 66 and ends the agreement information update processing. At this time, the web server 12 updates the agreement information of the user information by recording the update date information of the agreement terms document data acquired at step S402 as the agreement information of the user information in place of the server time at the point of time of agreement by the user 18.

In the above-mentioned embodiment, the conditions to display the agreement terms in the case where the user 18 requests to use the web service by using the information terminal 14 and the processing until the user information management data 66 is updated in the case where the user agrees to the agreement terms are explained. However, in the above-mentioned embodiment, explanation of the state where the agreement terms document data is updated as time elapses and of the display determination processing of the agreement terms in the case where the user 18 has changed the language at the time of use of the web service or in the case where a web service compatible language is added is omitted. Consequently, detailed explanation is given below by using specific examples.

### Specific Example 1

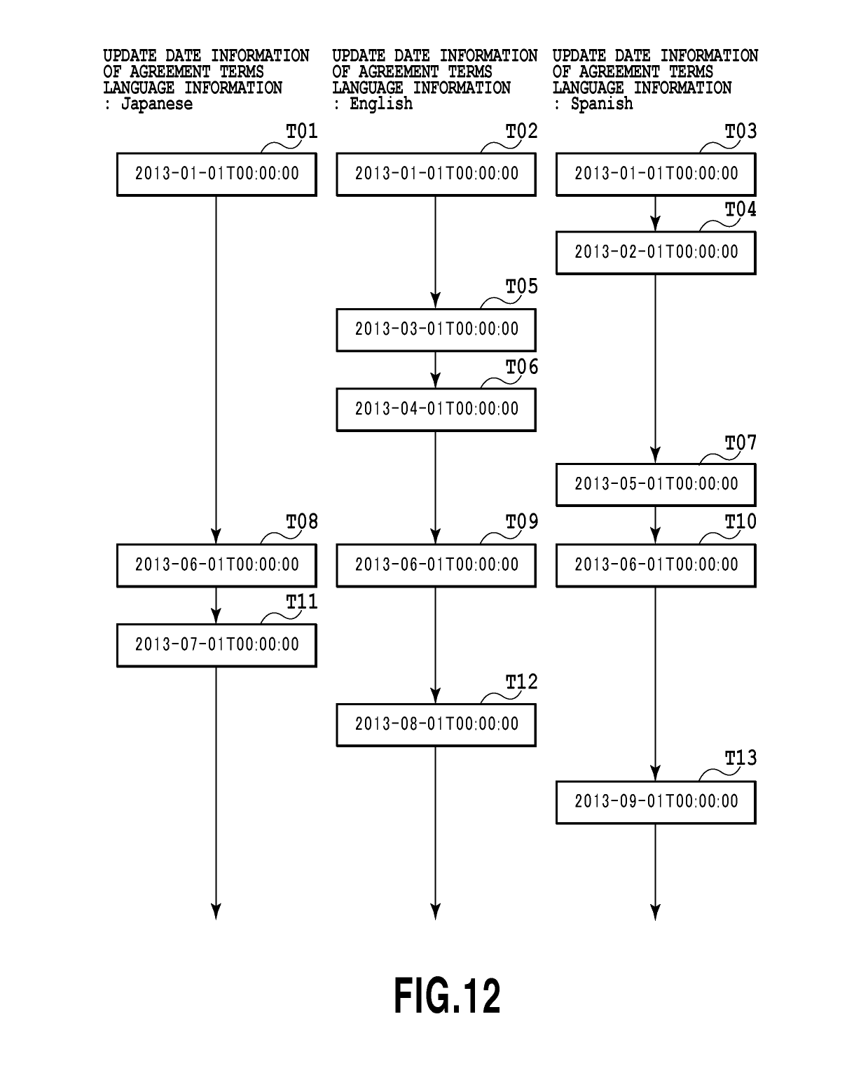

As a first specific example, a case is explained by using FIG. 12, where the user 18 switches language information and transmits a web service use request from the information terminal 14 in the web service in which provided services are different according to language.

FIG. 12 shows that as the result of update of the agreement terms document data 62 for each language, the update date information of the agreement terms included in the agreement terms management data 64 is updated and changed for each language.

Symbols T01, T02, and T03 in FIG. 12 are update date information of the agreement terms in the case where the web service is made available to the public. The web service is compatible with Japanese, English, and Spanish and the agreement terms are updated for each language. In the case where the agreement terms are updated and the necessity to gain agreement again of the user who has already agreed to the original agreement terms arises, the update date information is updated.

In the example, the user transmits a web service use request for the first time on Jan. 15, 2013 by selecting Japanese as language information. After that, the user uses the web service by transmitting the web service use request each time a month elapses (on 15 of every month). Hereinafter, in the present specification, the day is omitted and only the month is indicated, such as the access on Jan. 15, 2013 as “access of January” and the access on Feb. 15, 2013 as “access of February”.

In the access of January, it is assumed that the user agrees for the first time. By the first time agreement of the user, the update date information 101 is recorded in the user agreement information.

In the access of February, the agreement terms in Spanish are updated, and therefore, update date information T04 exists at the time of access. However, in the case where the user has selected Japanese as language information, the update date information 101 recorded as the user agreement information and the update date information 101 of the agreement terms are compared. As a result, in the display determination processing of the agreement terms, the agreement terms display request is not transmitted (flow from step S108 to step S114 in FIG. 6).

In the accesses of March and April, the agreement terms in English are updated, and therefore, update date information T05 and T06 exist respectively at the time of access. However, in the case where the user has selected Japanese as language information, the update date information 101 recorded as the user language information and the update date information 101 of the agreement terms are compared. As a result, in the display determination processing of the agreement terms, the agreement terms display request is not transmitted (flow from step S108 to step S114 in FIG. 6).

In the access of May, the agreement terms in Spanish are updated, and therefore, update date information T07 exists at the time of access. However, in the case where Japanese is still selected as language information by the user, the update date information 101 recorded as the user agreement information and the update date information 101 of the agreement terms are compared. As a result, in the display determination processing of the agreement terms, the agreement terms display request is not transmitted (flow from step S108 to step S114 in FIG. 6).

In the access of June, the agreement terms in all the languages are updated, and therefore, update date information T08, T09, and T10 exist at the time of access. In the case where the user has selected Japanese as language information, the update date information 101 recorded as the user agreement information and the update date information T08 of the agreement terms are compared. As a result, in the display determination processing of the agreement terms, the agreement terms display request is transmitted (flow from step S108 to step S112 in FIG. 6). In the case where the user agrees to the updated agreement terms, the update date information T08 is recorded in the user agreement information.

Next, it is assumed that the user switches the language information and transmits the web service use request. Specifically, in the access of July, the user changes from Japanese used until the access of June to Spanish as language information and transmits the web service use request.

In the access of July, the agreement information in Japanese is updated, and therefore, update date information 111 exists at the time of access. However, the user has selected Spanish as the language information, and therefore, the update date information 108 recorded as the user agreement information and the update date information T10 of the agreement terms for Spanish are compared. As a result, in the display determination processing of the agreement terms, the agreement terms display request is not transmitted (flow from step S108 to step S114 in FIG. 6).

In the access of August, it is assumed that the user returns the language information to Japanese again and transmits the web service use request, and in the same month, the user changes the language information to English and transmits the web service use request. In the case where the user transmits the web service use request by selecting Japanese as the language information, the update date information T08 recorded as the user agreement information and the update date information 111 of the agreement terms for Japanese are compared. As a result, in the display determination processing of the agreement terms, the agreement terms display request is transmitted (flow from step S108 to step S112 in FIG. 6). In the case where the user agrees to the agreement terms, in the user agreement information, the update date information T11 is recorded. Next, in the case where the user transmits the web service use request by selecting English as the language information, the update date information T11 recorded as the user agreement information and update date information T12 of the agreement terms for English are compared. As a result, in the display determination processing of the agreement terms, the agreement terms display request is transmitted (flow from step S108 to step S112 in FIG. 6). In the case where the user agrees to the agreement terms, in the user agreement information, the update date information T12 is recorded.

### Specific Example 2

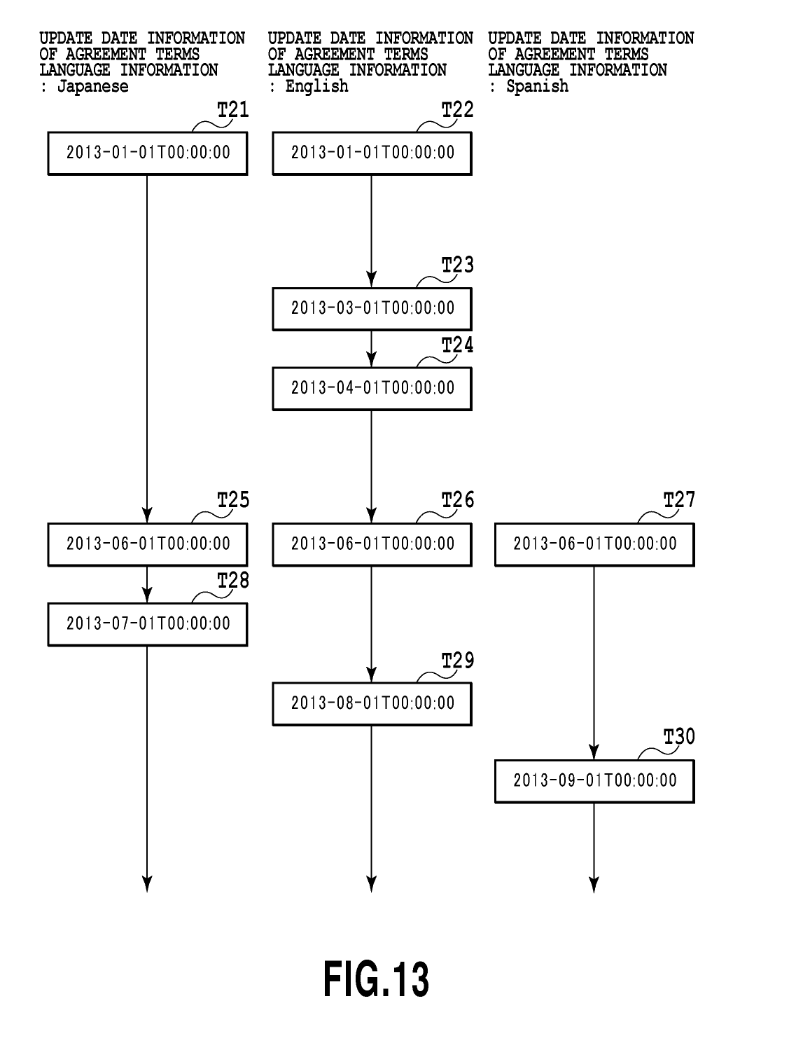

As a second specific example, the case where a new user uses the web service in an added language and the case where a conventional user having been using a language different from the added language uses the web service in the web service to which the compatible language is added are explained by using FIG. 13.

The user (hereinafter, user A) who uses the added compatible language (Spanish in the example in FIG. 13) starts using the web service from the access of June. On the other hand, the user (hereinafter, user B) who uses a language (in the example in FIG. 13, Japanese or English) different from the added compatible language has been using the web service before the access of June.

The agreement terms display determination in the access of January to the access of May of the user B is the same as that in the specific example 1, and therefore, explanation is omitted. After the access of May, as will be seen from FIG. 13, Spanish is added as a web service compatible language.

In the access of June, the user A transmits the web service use request by selecting Spanish as the language information. In the case where the user A agrees to the displayed agreement terms, as the agreement information of the user A included in the user information management data 66, update date information T27 is stored. At this time, the user has begun using the web service after the compatible language is added, and therefore, the user information of the user A is created newly.

On the other hand, it is assumed that in the access of June, the user B transmits the web service use request by selecting the language used hitherto (specifically, Japanese or English) as the language information. In this case, by the addition of the compatible language, there is a possibility that the configuration of the user information management data 66 has changed at the time of the access of June. In the present invention, as the user agreement information used in the agreement terms display determination, the recorded update date information of the agreement terms is used regardless of whether the number of compatible languages is increased or decreased. Consequently, in the case where the compatible language is changed, it is not necessary to change the user agreement information and it is possible to still use the user agreement information in the agreement terms display determination regardless of whether the number of compatible languages is increased or decreased.

It may also be possible for the user B to select the added compatible language (specifically, Spanish) as the language information and to transmit the web service use request. Alternatively, even in the case where the state where the compatible language used by the user B becomes no longer compatible in the web service and another piece of language information is selected is brought about, it is possible to use the agreement information of the user B on the user information management data in the agreement terms display determination processing.

In the embodiment described previously, the agreement terms management data 64 includes the update date information of the agreement terms document data 62 and the agreement terms display determination processing is performed by using the update date information indicating the update date of the update of the agreement terms, but the information used is not limited to the update date information. As an alternative, for example, it may also be possible to set the version number of the agreement terms at the time of creation of the agreement terms document data to 1 and to increase the version number to 2, 3, and so on, each time the agreement terms are updated, and to store the version number of the agreement terms to which the user has agreed as the agreement information of the user. In this case, in the agreement terms display determination processing, the version number in the agreement terms management data 64 and the version number in the user information management data 66 are compared. Then, in the case where the version number in the agreement terms management data 64 is larger than the version number in the user information management data 66, the agreement terms are displayed. Alternatively, it may also be possible to manage the version number by using figures including decimal fractions, such as 1.01, 1.02, and 2.00.

In the embodiment described previously, the display determination of the agreement terms at the time of use of the web service is explained, but the present invention is not limited to the web service. For example, it may also be possible to perform the agreement terms display determination processing at the time of download of the contents, such as support documents and operation manuals, provided by the web server, or programs used in the information terminal 14, such as drivers and firmware, other than programs on the web server. In this case, the information terminal 14 transmits a contents download request or a program download request to the web server 12 in place of the web service use request.

Further, in the embodiment described previously, the agreement terms display determination processing is performed at the time of transmission of the web service use request, but the present invention is not limited to the web service. For example, it may also be possible to request the agreement terms display determination processing by transmitting the user recognition information 70 to the web server 12 in the case where a program used by the information terminal 14 is stored in the storage unit 46 of the information terminal 14 and the program is activated and used.

In the case where the agreement terms are displayed for the function comprised by the information terminal 14, the information terminal 14 may not transmit the user recognition information 70 to the web server 12 and may perform also the agreement terms display determination processing. In such a case, for example, the web server 12 manages the agreement terms corresponding to each language. Then, in the case where the information terminal 14 activates and uses a specific program, the information terminal 14 acquires the update date information indicating the update date of the agreement terms corresponding to the used language from the web server 12. Then, by comparing the acquired update date information and the information indicating the time of agreement by the user stored within the information terminal 14, it is possible to perform the above-mentioned agreement terms display determination processing. Then, in the case where it is determined that the agreement terms are displayed, the language information indicating the used language is transmitted to the web server 12 and the agreement terms corresponding to the language are downloaded from the web server 12.

In the embodiment described above, as the method for notifying the agreement terms to a user, the display of the agreement terms is explained, but this is not limited. For example, there may be a case where voice related to the agreement terms is output from a speaker, not shown, of the information terminal 14.

In the above embodiment, even though a user changes the used language, in the case where the user has agreed to the agreement terms in the language before the change, there is a case where the agreement terms in the language after the change are not notified. Therefore, for example, in the case where the agreement terms in the language after the change are updated because of an error in spelling or minute modification, it is possible to prevent the agreement terms whose contents are the same as the contents already agreed to after the change of the language from being notified to the user.

Further, in the above embodiment, the agreement terms are managed by the update date corresponding to each of the plurality of languages, but it may also be possible to manage the agreement terms by version information, not limited to the update date. In such a case, for example, in the case where the contents of the agreement terms in a certain language are changed, the version information of the agreement terms is also updated. On the other hand, in the case where the agreement terms are updated because of an error in spelling, minute modification, etc., it may also be possible not to update the version information. Alternatively, it may also be possible to provide grades to the update within the version information. For example, the format of the version information is set to “x. yyy. zzz” and in the case where the contents are changed, the figures of x and y are changed and in the case where the change is small, such as an error in spelling, wrong writing, etc., z is changed. Then, in the case where the version information of the agreement terms to which the user has agreed and the version information at the time of service use request by the user are different in x and y, the agreement terms are notified to the user and in the case where z is different, notification is not made.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment (s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-166691, filed Aug. 9, 2013, which is hereby incorporated by reference herein in its entirety.

What is claimed is:

1. A system for determining whether to notify agreement terms to use a predetermined function to a user, the system comprising:
an acquisition unit configured to acquire language information for specifying a language corresponding to a user and agreement information on a date of agreement of the agreement terms by the user; and
a determination unit configured to determine, in a case where a request to use the predetermined function from a user is received, whether to notify the agreement terms to the user based on a date of the agreement terms corresponding to language information acquired by the acquisition unit of a plurality of agreement terms corresponding to a plurality of languages, respectively, and agreement information acquired by the acquisition unit.

2. The system according to claim 1, wherein
as the user agreement information, update date information of the agreement terms to which the user has agreed is set instead of a time at the point of time of agreement by the user.

3. The system according to claim 2, wherein
the determination unit determines whether to notify agreement terms to a user by comparing an update date indicated by the update date information set in the user agreement information and an update date indicated by update date information of agreement terms document data for the specified language.

4. The system according to claim 3, wherein
in a case where the update date indicated by the update date information of the agreement terms document data for the specified language is earlier than the update date indicated by the update date information set in the user agreement information, the determination unit determines to display agreement terms to the user.

5. The system according to claim 1, wherein
the determination unit determines whether to notify agreement terms to a user by comparing a version number of the agreement terms set in the user agreement information and a version number of the agreement terms document data for the specified language.

6. The system according to claim 1, wherein
in a case where the update date of the agreement terms corresponding to the language information of the plurality of agreement terms corresponding to the plurality of languages, respectively, is later than the date of the agreement information for the language information, the determination unit determines to notify the agreement terms to the user.

7. The system according to claim 6, wherein
in a case where the update date of the agreement terms corresponding to the language information of the plurality of agreement terms corresponding to the plurality of languages, respectively, is earlier than the date of the agreement information corresponding to a language different from the language corresponding to the language information, the determination unit determines not to notify the agreement terms to the user.

8. The system according to claim 1, comprising an information terminal and a server connected with the information terminal, wherein
the predetermined function is performed by using the server in response to instructions of a user to the information terminal.

9. The system according to claim 8, wherein
the predetermined function is a web service, downloading of contents, or downloading of a program.

10. The system according to claim 8, wherein
the information terminal or the server comprises the determination unit.

11. A method for determining whether to notify agreement terms to use a predetermined function to a user, the method comprising the steps of:
acquiring language information for specifying a language corresponding to a user and agreement information on a date of agreement of agreement terms by the user; and
determining, in a case where a request to use the predetermined function from a user is received, whether to notify the agreement terms to the user based on an update date of the agreement terms corresponding to the acquired language information of a plurality of agreement terms corresponding to a plurality of languages, respectively, and the acquired agreement information.

12. A non-transitory computer readable storage medium storing a program for causing a computer to perform the method according to claim 11.
